(19) United States
(12) Patent Application Publication
(10) Pub. No.: US 2005/0108127 A1
(43) Pub. Date: May 19, 2005

(54) Stored value lottery card and methods

(75) Inventors: Jaime Paul Brown, Denver, CO (US); Kenneth Algiene, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/744,888

(22) Filed: Dec. 23, 2003

Related U.S. Application Data
(60) Provisional application No. 60/520,486, filed on Nov. 14, 2003.

(51) Int. Cl. G06F 17/60

(52) U.S. Cl. 705/35; 705/38

(57) ABSTRACT

In one embodiment, a method for making a lottery pick comprises selecting a lottery presentation instrument having stored thereon an account identifier. The account identifier and the purchase amount are transmitted from a point of sale device to a host computer system. Also transmitted to the host computer system is a request to play a lottery. The request includes the account identifier. The player selects a lottery pick, and a confirmation of the lottery pick is provided to the player.

### CROSS-REFERENCES TO RELATED APPLICATIONS

This application is a non-provisional application claiming the benefits of U.S. Provisional Application No. 60/520,486, filed Nov. 14, 2003, the complete disclosure of which is herein incorporated by reference.

This application is also related to U.S. Provisional Patent Application Ser. No. 60/520,488 filed concurrently herewith, entitled “System for Accounting” (temporarily referenced by Attorney Docket No. 020375-018810US); U.S. Provisional Patent Application Ser. No. 60/520,432 filed concurrently herewith, entitled “Bulk Card Ordering System and Methods” (temporarily referenced by Attorney Docket No. 020375-043000US); U.S. Patent Application Ser. No. 10/714,437 filed concurrently herewith, entitled “Open Loop Stored Value System” (temporarily referenced by Attorney Docket No. 020375-047500US); U.S. Patent Application Ser. No. 10/744,441 filed concurrently herewith, entitled “Open Loop Stored Value Account Configuration” (temporarily referenced by Attorney Docket No. 020375-047700US), which are incorporated by reference in their entirety.

### BACKGROUND OF THE INVENTION

This invention relates generally to the field of lotteries, and in particular to ways to play various types of lotteries. In one specific example, the invention relates to systems and techniques to pay for and to participate in a lottery.

Various states have enacted statutes establishing lotteries. Once such example is the state of Colorado. As explained on their official web site (www.coloradolottery.com), lottery products are sold at retail locations. In return for selling the lottery products, the retailers get various commissions and bonuses. In the state of Colorado, such lottery products include Scratch, Lotto, Cash 5 and Powerball. These games are played by purchasing a ticket at the retail location using a point of sale device. To get a ticket, the player must make a cash payment (which includes payments using a debit card, check, or the like) to the clerk who then issues the ticket using the point of sale device. At the prescribed time, winning numbers are generated. The winning numbers may be displayed at the retail locations and certain payouts may also be redeemed at the retail locations.

Scratch games are played by purchasing a card with a latex covering. This covering is scratched off to see if the numbers or symbol match a winning number or symbol. If so, the winning ticket may be redeemed for a prize. Lotto is a jackpot game where players select six numbers from a field of 42 and prizes are awarded for matching 3, 4, 5, or 6 or the numbers. The numbers may be generated from the point of sale device using a “quick pick” selection as well. The amount of the prize depends on how many numbers match.

The Play Cash 5 game requires the player to select five numbers from a field of 32 possible numbers. If a player matches 2, 3, 4, or 5 numbers, they win a prize. With Powerball, players pick 5 out of 53 numbers and one Powerball number between 1 and 42. The lure of Powerball is that the jackpot starts and $10 million and the growth potential is large.

Other states offer similar lottery products. This invention relates to techniques and systems to facilitate these and other kinds of lottery systems.

### BRIEF SUMMARY OF THE INVENTION

In one embodiment, the invention provides a method for playing a lottery that comprises storing at a host computer system account identifiers that are also stored on corresponding presentation instruments. The host computer system receives from a point of sale device one of the account identifiers from one of the presentation instruments and a value to associate with one of the account identifiers. The host computer system also receives a request to apply at least some of the value to a lottery pick. The lottery pick may then be associated with the account identifier. Once a winning identifier is generated, it is compared with the lottery pick at the host computer system to determine if the lottery pick is a winner. In this way, a lottery may be played by purchasing a presentation instrument and then associating a lottery pick with the account identifier that is associated with the presentation instrument. The same presentation instrument may also be used to play other lotteries and to make multiple picks for the same lottery.

In one aspect, the request to apply at least some of the value is received from a telecommunications system. In this way, the lottery pick may be selected using a phone. Alternatively, the request to apply at least some of the value is received from a web server computer. In this way, the lottery pick may be selected from a web site.

In another aspect, the host computer system subtracts an amount from the stored value based on a cost associated with the lottery pick. The host computer system may also be used to produce a confirmation of the lottery pick. This confirmation may be a receipt having the lottery pick. In such cases, the receipt may be printed at a point of sale device after reading the account identifier from the presentation instrument.

Conveniently, the winning identifier may be received from a state lottery computer system. In another aspect, the host computer system may transmit information on the winner and a winning amount associated with the winner. This information may be transmitted from the host computer system to a point of sale device for display by the point of sale device. Also, the host computer system may be used to associate the winning amount with the account identifier.

In a further aspect, a reload amount may be transmitted to the host computer system. The reload amount may then be associating with the account identifier.

The invention also provides a method for making a lottery pick. According to the method, a lottery presentation instrument is selected. Stored on the presentation instrument is an account identifier. The account identifier and a purchase amount is transmitted from a point of sale device to a host computer system. Also transmitted to the host computer system is a request to play a lottery which includes the account identifier. The request to play also includes a lottery pick. After the lottery pick is made, a confirmation of the lottery pick is sent to the requester. For example, a receipt may be printed with the confirmation. In some cases, the request to play may be for another type of game and may not require a lottery pick. However, the game may still be paid for using the stored value.

The request to play the lottery may be received from a phone, a web site or the like. In one option, the player may select a date in which the lottery is to be played. In another option, the lottery pick may be randomly generated or selected by the player. If desired, the player may also select multiple lottery picks. The stored value amount that is associated with the presentation instrument may be reduced based upon the number of lottery picks selected.

If needed, the player may transmit to the host computer system a reload amount to associate with the account identifier. In this way, value may be added to the account so that additional lotteries may be played.

The invention also provides a computerized lottery system. The system comprises a plurality of presentation instruments that each have a unique account identifier. The system also includes a host computer system having a record of the account identifiers. The host computer system is configured to receive from a point of sale device one of the account identifiers from one of the presentation instruments and a value to associate with the account identifier. The host computer system is also configured to receive a request to apply at least some of the value to a lottery pick, and to associate the lottery pick with the account identifier. Further, the host computer system is configured to compare a winning identifier with the lottery pick to determine if the lottery pick is a winner.

The host computer system may also be configured to reduce the value associated with the account based on how many lottery picks are chosen. The host computer system may also be configured to increase the value associated with the account identifier when a reload amount is received. In some cases, the host computer system may be configured to add a winning amount to the value associated with the account identifier. This may be used to play additional games or to make other types of purchases or redemptions.

In one aspect, the presentation instrument may be used to make purchases other than those associated with a lottery. In such cases, the host computer system may be configured to receive a request to debit the value based on a purchase of an item and to debit the value.

### BRIEF DESCRIPTION OF THE DRAWINGS

FIG. 1A is a front view of one embodiment of a presentation instrument that may be used with the invention.

FIG. 1B is a rear view of the presentation instrument of FIG. 1A.

FIG. 2 is a schematic view of a diagram of a point-of-sale device that may be used in accordance with the present invention.

FIG. 3 is a schematic diagram of a system that may be utilized to manage and play various lotteries according to the invention.

FIGS. 4A and 4B are flow charts illustrating one method for playing a lottery according to the invention.

### DESCRIPTION OF THE SPECIFIC EMBODIMENTS

In one aspect, the invention provides systems and methods for playing various lotteries. Examples of lotteries that may be played using the invention include those offered by most state lottery systems, such as Powerball, Lotto and the like, although the invention is not limited to only these types of lotteries. The invention is particularly suitable for games where a number or other identifier is selected, and a winner is determined by randomly selecting a winning number or identifier. If the player's selection matches some or all of the winning number or identifier, the player is deemed a winner and may claim a prize. Although useful with government sanctioned lotteries, the invention may be used with other types of organizations including charities, social organizations, company raffles and the like.

To facilitate payment, the invention may utilize stored value accounts. In this way, when a player wishes to play one or more games, the payment may be made by debiting a stored value account. The stored value of an account typically has an associated identifier that may be conveniently be stored on a presentation instrument, such as a card. Such presentation instruments may initially be in an inactive state where no value is associated with the presentation instrument. To associate a value with the account, a consumer may purchase one of the cards for a certain amount, such as fifty dollars. Conveniently, this transaction (referred to as an activation) may be processed at a merchant or retail location. In such cases, the merchant collects a payment, using cash, credit card, debit card or any other acceptable form of payment, and enters this information into a point-of-sale device. The account identifier associated with the presentation instrument is also entered into the point-of-sale device. For example, the identifier may be stored on a magnetic stripe, on a bar code label, or the like. Examples of such point-of-sale devices that may be used to capture and/or transmit such information to a host computer system are described in copending U.S. application Ser. No. 10/116,619, filed Apr. 3, 2002, the complete disclosure which is herein incorporated by reference. However, it will be appreciated that the invention is not intended to be limited to a specific type of processing/reading device. For example, other ways of transmitting information include by telephone (such as by using an IVR system), mobile or wireless devices, by contacting a customer service representative or the like. Reload transactions, where value is added to an existing account, may occur in a similar manner.

Such information is transmitted to the host computer system which has a record of the account identifier. Such information may be transmitted across a variety of networks including telephone networks, credit card networks, wide area networks, the Internet, wireless networks, and the like. Further, depending on the type of processing device used to transmit the information, such devices may also be coupled to a financial network, such as a credit card or ATM network, or may have a direct connection to the host computer system. If connected to a financial network, the host computer system may be configured to determine that the transaction is related to a stored value account rather than a traditional credit or debit card and may process the information appropriately.

When such information is received at the host computer system, the value that was paid by the consumer is associated with the account identifier. In so doing, the account is activated so that the consumer may then use the presentation instrument for playing a lottery. In some cases, the stored value may be used in other applications as well. For example, the stored value account may be used for making purchases. For instance, a stored value transaction may ride the financial rails of so-called gift card transactions currently processed by ValueLink of First Data Corporation. In this way, a presentation instrument that is used to play lottery games may also be used to make purchases. In a similar manner, if a player wins a lottery, the winnings may be credited to the same stored value account and used to make subsequent purchases.

To play a lottery (or to redeem part or all of the value associated with the presentation instrument (sometimes referred to as a redemption transaction)), the consumer simply needs to provide the account identifier at the time a ticket is to be purchased or a redemption transaction is to be performed. For example, if a consumer desired to play a lottery game, the player may simply provide the presentation instrument to the clerk at a retail location, using an IVR system or the like. If provided at a retail location, the identifier may be read from the presentation instrument using a point-of-sale device and transmitted back to the host computer system. Along with this information, the game that the player wishes to play may also be transmitted. This may be entered and transmitted using the point of sale device, or using any of the techniques previously described. The host computer system is configured to determine the amount of value remaining in the account and to debit the account by the cost of the game. Information confirming the transaction may be transmitted back to the point-of-sale device. Such information may include a lottery pick selected by the player or randomly generated by the host computer system, the point of sale device, or the like. In some cases, such as with scratch and win games, the player may be issued a ticket having regions that may be scratched off in order to play a game.

Other information regarding the transaction that may be transmitted back to the point-of-sale device includes the amount debited, the new balance, the date of play, rules of the game, and the like. Some or all of this information may be displayed by the point-of-sale device and may optionally be printed to provide a paper receipt.

Consumers or players may perform transactions, such as redemptions, activations, reloads, requests to play and the like at merchant locations, such as at retail stores, using the Internet or from some other type of network, including the phone network. If needed, a ticket or confirmation may be printed showing the purchase, requests to play, lottery picks and the like. If at a point of sale location, an associated printer may be used to print this information. Similarly, if at a personal computer (such as when accessing the system using the Internet), an associated printer may be used. In cases where a game is played using a IVR system, the player could go to a web site, a point of sale location or the like to print the confirmation.

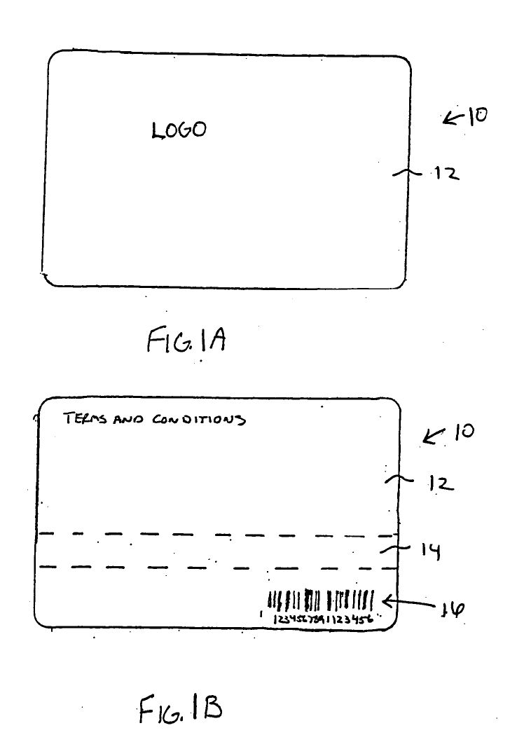

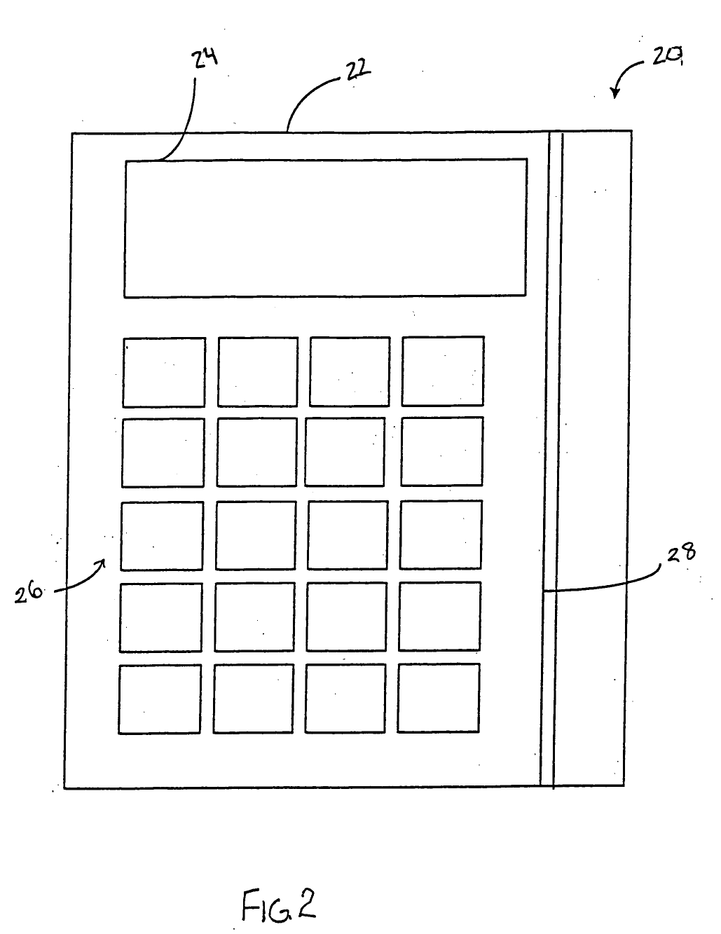

Referring now to FIGS. 1A and 1B, one embodiment of a presentation instrument 10 that may be used with the invention will be described. In general, the presentation instruments of the invention may be constructed of a wide variety of materials that are capable of storing an identifier that uniquely identifies the associated account. For example, the material may comprise a card 12 (that in turn may be constructed of plastic, cardstock, paper, or the like). Other materials include a computer disk (such as a CD, DVD or the like) or other tangible media. Further, the identifier may be stored in a variety of formats, such as in print, on magnetic media (such as a magnetic stripe 14), in a bar code format 16, in a computer processor (also known as a smart chip) or the like. Appropriate readers may be employed at the point-of-sale to read such formats and then transmit them to the host computer system for processing. Card 12 may also include lottery identification information, such as a name, logo, or the like.

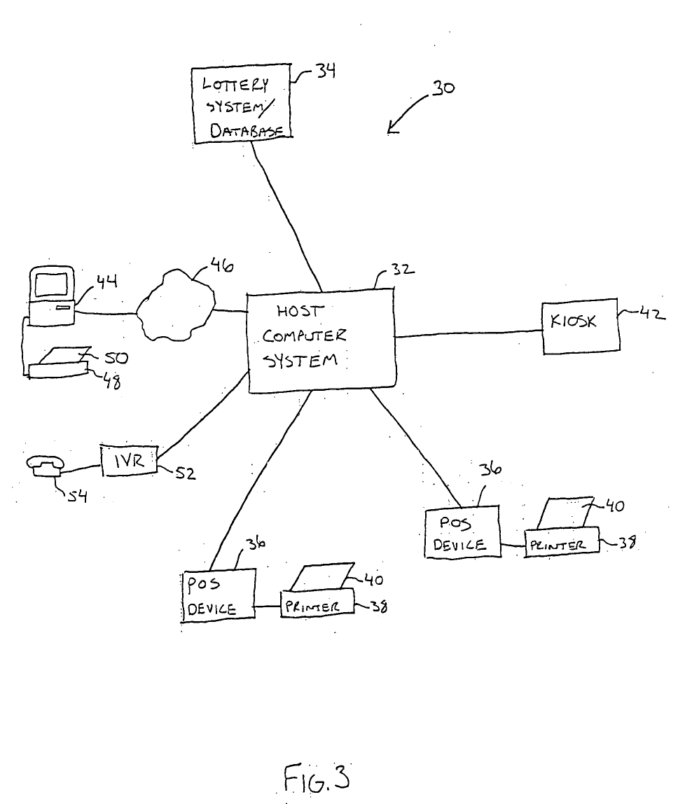

Referring now to FIG. 2, a point-of-sale device 20 that may be used will be described in greater detail. In so doing, it will be appreciated that the invention is not intended to be limited for use with only a specific type of point-of-sale device. Indeed, any type of processing or computing device that may transmit and receive data over a network may be used.

Point-of-sale device 20 comprises a housing 22 having a display screen 24 and input devices 26. Conveniently, input device 26 may comprise keys or buttons that may be depressed to enter information into a point-of-sale device 14. Input devices 26 may each be associated with one or more letters or other alpha numeric characters, or may operate as function keys.

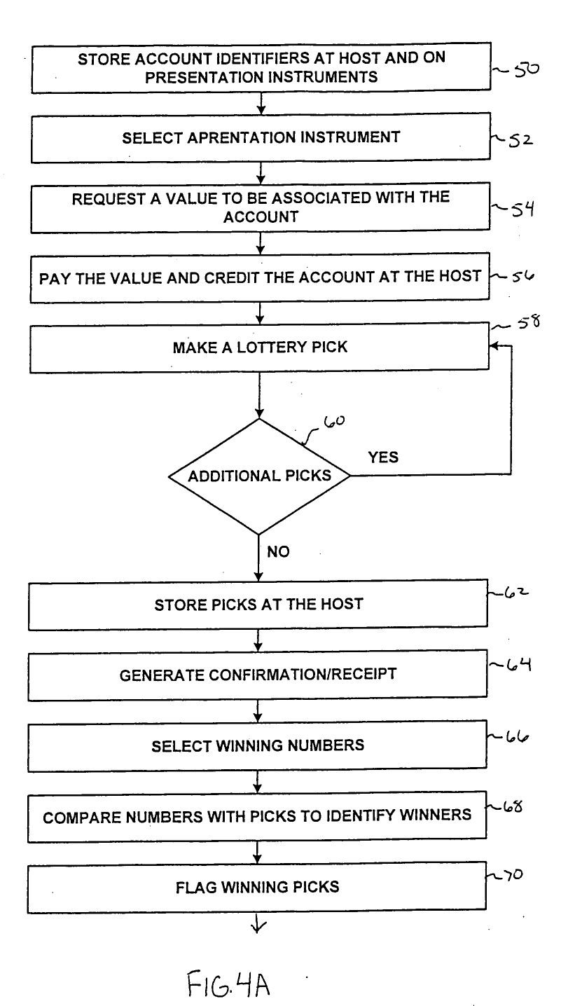

Referring now to FIG. 3, one embodiment of a lottery management system will be described. Lottery management system 30 comprises a host computer system 32 that is used to store a wide variety of information relating to stored value accounts as well as to facilitate management of such accounts and management of various aspects of a lottery. One of the functions of host computer system 32 is to maintain account identifiers for each of the accounts and an associated value, if available. As accounts are activated, credited and/or debited, host computer system 32 is employed to perform these functions in a manner similar to that described herein, as well as in copending U.S. Application No. 60/392,958, filed Jun. 28, 2002, U.S. application Ser. No. 10/268,040, filed Oct. 8, 2002, U.S. application Ser. No. 10/267,180, filed Oct. 8, 2002, U.S. application Ser. No. 10/286,006, filed Nov. 1, 2002, U.S. application Ser. No. 10/356,207, filed Jan. 30, 2003, U.S. application Ser. No. 10/371,167, filed Feb. 21, 2003, the complete disclosures of which are herein incorporated by reference. As such, host computer system 32 may include appropriate hardware, software and databases for these functions as is known in the art. Host computer system 32 may also include appropriate inputs and outputs for receiving and transmitting information in electronic form. For example, information may be received from point-of-sale devices, voice response units, server computers, personal computers, wireless devices and the like. Similarly, outputs may be transmitted to any device capable of receiving electronic documents.

In some cases, the account identifiers may be provided to host computer system 32 from a lottery database 34 or other type of computer system. In this way, a government entity overseeing the lottery can select and transmit the account identifiers to host computer system 32. Alternatively, host computer system 32 may generate its own account identifiers. The account identifiers may also be provided to a production facility to store the account identifiers on presentation instruments.

Lottery database 34 may also be used to provide winning numbers to host computer system 32 so that winners may be determined as described herein. Alternatively, winning numbers could be generated directly at host computer system 32.

System 30 may utilize a variety of devices to associate a value with an account identifier so that a game may be paid for and played. For example, a traditional point of sale device 36 may be configured to communicate with host computer system 30. To activate an account, the identifier from the presentation instrument may be entered into point of sale device 36 and transmitted to host computer system 32 which checks to make sure the identifier is valid. If so, the amount of value that is to be associated with the account identifier is entered into point of sale device 36 and transmitted to host computer system 32. This value is stored in a database along with the account identifier. If value is to be added to an existing account, it may be done in the same way. Optionally, a printer 38 may be used to produce a receipt 40 giving the details of the transaction.

As another example, presentation instruments may be purchased from and/or activated at a kiosk 42. One example of such a kiosk is described in copending U.S. application Ser. No. 10/225,410, filed Aug. 20, 2002, the complete disclosure of which is herein incorporated by reference. Using kiosk 42, the account identifier and payment amount may be transmitted to host computer system 32 in a manner similar to that described with point of sale devices 36. Also, kiosk 42 may print a receipt as well.

Another device for adding value to an account is using a personal computer 44 that communicates with host computer system 32 using a network 46, such as the Internet. Computer 44 may comprise essentially any type of computing device capable of transmitting data and may include an interface, such as a web browser, to facilitate entry and display of information. Using computer 44, information on the account identifier as well as a payment instrument, such as a credit card, debit card, stored value card, bank account, or the like, may be entered and transmitted to host computer system 32 where it is saved. A printer 48 may be used to print a receipt 50 containing the details of the transaction.

As a further example, an account identifier and payment information may be transmitted to an interactive voice response (IVR) system 52 using a phone 54. In some cases, IVR system 52 could be substituted with a live operator, such as a customer service representative, who enters the information into a computer (similar to computer 44).

To play a game, host computer system 32 may be accessed using any of the devices described herein. Depending on the game that is played, the player transmits certain information to host 32. For example, for a traditional lottery, the player enters the account identifier where the host computer system 32 checks to see if enough value is associated with the account to play the game. If so, the player may also transmit a lottery pick. The player may select his own pick or request that the system generate a quick pick. The player may also select a date at which the lottery is to be played. This information is then stored at the host computer system 32 until the lottery is played. The account may also be debited by the amount required to play the lottery. In order to receive confirmation of the lottery pick and the payment amount, a receipt may be printed using any of the printers. In cases where a pick is selected but no printer is available (such as by using a phone), the player may access another device, such as POS device 36, which can read the identifier and then cause a ticket to be printed based on the previous pick.

Once a lottery is played, the winning number may be stored in host computer system 32. This number may be compared with all of the other played numbers to determine any potential winners. This information may also be stored at host computer system 32 and could also be transmitted to lottery database 34. If a winning player desires, any winnings may be credited to their stored value account and used to play other lotteries or to make other purchases using their stored value account.

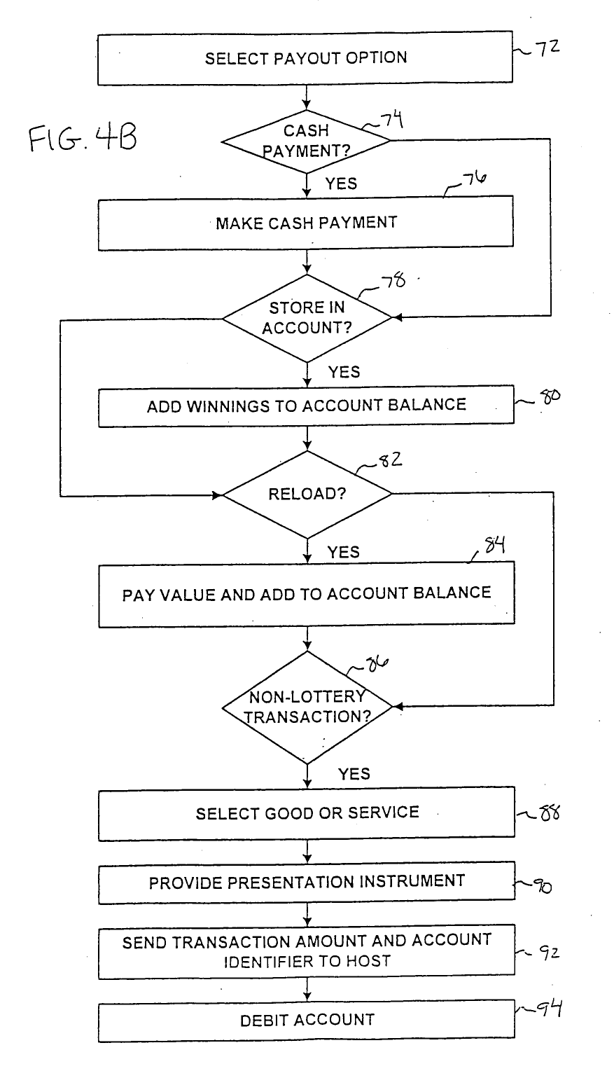

Referring now to FIGS. 4A and 4B, a method for opening an account and playing a lottery will be described. As shown in step 50, account identifiers are stored at a host computer and on presentation instruments. When ready to open an account, a person selects a presentation instrument as shown in step 52. The person also selects a value that is to be associated with the account as shown in step 54. The person pays for the value using cash, check, a debit card, a stored value card, a bank account or the like. This value is transmitted to the host and the associated account is credited as shown in step 56.

While making the purchase transaction, or at a subsequent time, a person may make a lottery pick as shown in step 58. The lottery pick may be made by the person who purchased the card or by another person. For instance, the presentation instrument may be purchased as a gift for someone else.

In step 60, the player may choose to make additional picks. If additional picks are made, the process goes back to step 58. For each pick that is selected, the host checks to make sure enough value is in the account and debits the account accordingly. If there is insufficient value, the player is notified and given the opportunity to pay for the play. Each time a pick is made, it is stored at the host as shown in step 62. A confirmation or receipt is also generated as shown in step 64. The receipt may include information such as the player's pick, any rules, the amount paid, the date when the lottery is to be played, the date and time of the pick, and the like. In some cases, this information could also be stored on the presentation instrument.

At an appointed time, a winning number is selected as shown in step 66. This may be done separate from the host computer and then supplied to the host, or even could be done by the host computer. The host computer may also be used to compare the winning number with the picks to determine any winners as shown in step 68. These may be flagged at the host computer as shown in step 70.

If a player is a winner, the player may select a variety of payout options as shown in step 72. For each option, the winner may provide the receipt (or in some cases the presentation instrument) as proof of being a winner. For example, a winner may select a cash payment as shown in step 74. If a cash payment is selected, the winner selects the payout in cash as shown in step 76. This may be received, for example, at a retail location having a point of sale device and a cash register. For larger payments, the winner may be required to pick up the funds as a check or other negotiable instrument.

As another payout option, the winner may receive the winnings in an account as shown in step 78. For instance, the winnings may be added to the winner's stored value account as shown in step 80. This account may be the same one used to pay for the lottery pick, another stored value account, a bank account, or the like. This account may be credited using the host computer directly, through an ACH or ATM transaction, or the like.

At any time an account holder may wish to add value to an account as shown in step 82. This may be accomplished by providing the account identifier to the host computer along with a payment amount as shown in step 84. The host computer may add this to the account balance.

The stored value account may also be used for non-lottery transactions as well as shown in step 86. For example, the stored value may be used to purchase goods or services as shown in step 88. After making a selection, the presentation instrument may be provided at the point of sale as shown in step 90. Alternatively, the account identifier could be provided, such as when making an Internet purchase or mail order purchase. The account identifier is transmitted to the host computer (step 92) where the account is debited (step 94).

The invention has now been described in detail with respect to certain embodiments. However, it will be appreciated that certain changes and modifications may be practiced within the scope of the appended claims.

1. A method for playing a lottery, the method comprising:
storing at a host computer system account identifiers that are also stored on corresponding presentation instruments;
receiving at the host computer system from a point of sale device one of the account identifiers from one of the presentation instruments and a value to associate with one of the account identifiers;
receiving at the host computer system a request to apply at least some of the value to a lottery pick;
associating the lottery pick with the account identifier; and
comparing a winning identifier with the lottery pick at the host computer system to determine if the lottery pick is a winner.

2. A method as in claim 1, wherein the request to apply at least some of the value is received from a telecommunications system, and wherein the lottery pick was selected using a phone.

3. A method as in claim 1, wherein the request to apply at least some of the value is received from a web server computer where the lottery pick was selected from a web site.

4. A method as in claim 1, further comprising receiving multiple lottery picks and associate the multiple lottery picks with the account identifier.

5. A method as in claim 1, further comprising subtracting an amount from the stored value based on a cost associated with the lottery pick.

6. A method as in claim 1, further comprising producing with the host computer system a confirmation of the lottery pick.

7. A method as in claim 6, further comprising printing a receipt with the confirmation.

8. A method as in claim 7, further comprising printing the receipt at a point of sale device after reading the account identifier from the presentation instrument.

9. A method as in claim 1, wherein the winning identifier is received from a state lottery computer system.

10. A method as in claim 1, further comprising transmitting from the host computer system information on the winner and a winning amount associated with the winner.

11. A method as in claim 10, further comprising transmitting from the host computer system to a point of sale device information on the winning amount.

12. A method as in claim 10, further comprising receiving at the host computer system a request to associate the winning amount with the account identifier.

13. A method as in claim 1, further comprising receiving at the host computer system information on a reload amount, and associating the reload amount with the account identifier.

14. A method for making a lottery pick, the method comprising:
selecting a lottery presentation instrument having stored thereon an account identifier;
transmitting from a point of sale device to a host computer system the account identifier and a purchase amount;
transmitting to the host computer system a request to play a lottery, wherein the request includes the account identifier;
selecting a lottery pick; and
providing a confirmation of the lottery pick.

15. A method as in claim 14, wherein the request to play the lottery is received from a phone or a web site.

16. A method as in claim 14, further comprising selecting a date in which the lottery is to be played.

17. A method as in claim 14, wherein the lottery pick is randomly generated.

18. A method as in claim 14, further comprising selecting multiple lottery picks.

19. A method as in claim 14, further comprising reducing the purchase amount based upon the selection of the lottery pick.

20. A method as in claim 14, further comprising transmitting to the host computer system a reload amount to associate with the account identifier.

21. A method as in claim 14, further comprising printing a receipt with the confirmation.

22. A method as in claim 14, further comprising transmitting a request to the host computer system to associate a winning amount with the account identifier.

23. A computerized lottery system, comprising:
a plurality of presentation instruments that each have a unique account identifier;
a host computer system having a record of the account identifiers;
wherein the host computer system is configured to:
receive from a point of sale device one of the account identifiers from one of the presentation instruments and a value to associate with the account identifier;
receive a request to apply at least some of the value to a lottery pick;
associate the lottery pick with the account identifier; and
compare a winning identifier with the lottery pick to determine if the lottery pick is a winner.

24. A system as in claim 23, wherein the host computer system is further configured to reduce the value associated with the account based on how many lottery picks are chosen.

25. A system as in claim 23, wherein the host computer system is further configured to increase the value associated with the account identifier when a reload amount is received.

26. A system as in claim 23, wherein the host computer system is further configured to add a winning amount to the value associated with the account identifier.

27. A system as in claim 23, wherein the host computer system is further configured to receive a request to debit the value based on a purchase of an item and to debit the value.
